(19) United States
(12) Patent Application Publication
(10) Pub. No.: US 2011/0270847 A1
(43) Pub. Date: Nov. 3, 2011

(54) Method and system for appraising the extent to which a publication has been reviewed by means of a peer-review process

(76) Inventor: Adam Etkin, New Rochelle, NY (US)

(21) Appl. No.: 12/772,209

(22) Filed: May 1, 2010

(51) Int. Cl. G06F 17/30

(52) U.S. Cl. 707/748; 707/E17.005; 707/E17.058

(57) ABSTRACT

A method and system appraises the extent to which an article has been reviewed by means of a peer-review process such that a user conducting a search with a search engine via an internet connected electronic device can infer the quality of the publication in relation to other publications returned in the search results displayed on the electronic device. A peer review score is calculated from the metadata of the article. The peer review score is displayed next to a link to the article returned in the search results from the search engine. The peer review score indicates the relative thoroughness of the peer review process that the article underwent.

### BACKGROUND

Peer-reviewed journals play an important role in advancing scientific thought, knowledge, and understanding in virtually every aspect and every specialty of modern science. Before an article is published, whether in print or online, it must first pass through a peer-review process. The peer-review process is meant to ensure that every article published meets the highest standards demanded by the scientific method. As a practical matter however, journals must claim to be peer-reviewed if they have any chance of surviving in the competitive industry of modern scientific publishing.

In the peer-review process, an author submits an article to a journal and the article is reviewed by experts in the field, or peers. These peers, which may include an editor-in-chief (EIC) of the journal, associate editors (AE) of the journal, and reviewers (R) comprised of independent scholars and experts. The peers review and comment on the article and these comments are returned to the author so as to help him improve the article and resubmit it to the journal as a new revision (R). A decision is made by the editor-in-chief or associate editors to accept or deny the article for publication in the journal. Accepted articles may be accepted as submitted (R=1) or may require revisions (R>1) before being published.

The internet has improved many aspects of article submissions, the peer-review process, and scientific publishing. For example, the following U.S. Patents and Patent Applications, which are hereby incorporated by reference, disclose methods and systems for pre-publication peer-review and publishing articles: U.S. Pat. No. 7,007,232, U.S. Pat. No. 7,263,655, U.S. Pat. No. 7,539,938, US2006/0123348, US2008/0147661, US2008/0288324, and US2009/0204469.

When carried out properly, the peer-review process can be extremely effective in making sure that inferior papers and research do not get published. Unfortunately, many papers are published after very little or mediocre reviews by peers. Competition in the scientific publishing industry, competition between scientists, the politics and economics of academic or scholarly research, and the ease with which articles can be published via the internet, have lead many journals to take shortcuts in the peer-review process. Thus, there are an increasing number of articles published each year that do not hold up under the scrutiny of science or of peers, even though the journal claims to be peer-reviewed.

There have been efforts in the industry to provide a measure of the importance of a journal or published article but these methods all rely on methods that work on network topologies in one form or another. Impact factor (IF) is one such measure. The impact factor measures the average number of citations to papers in a journal over a two year period. The more citations received by articles in a journal, the higher the impact factor. Other methods, such as CiteRank, Eigenfactor, Google Scholar, combine aspects of internet link-analysis algorithms, such as Google's Pagerank, with aspects of citation analysis.

So, these methods measure a network of links, whether from citations or from URLs in internet accessible documents. As such, they primarily measure the popularity of an article or journal. The reasons for that popularity, whether positive or negative, are at best a secondary concern and in most cases difficult or not possible to measure.

Even more troublesome is that the quality of peer review is unknown and cannot be know from any of these methods. A measure of the thoroughness of a peer review of an article, or a peer review score, could help a scientist or researcher locate the thoroughly reviewed articles and avoid the inferior ones. Such a measure could also help legitimize and raise the status of a journal. Thus, it would be desirable to have a method and system for appraising the extent to which a publication has been reviewed by means of a peer-review process.

### SUMMARY

A method and system appraises the extent to which a publication has been reviewed by means of a peer-review process such that a user conducting a search with a search engine via an internet connected electronic device can infer the quality of the publication in relation to other publications returned in the search results displayed on the electronic device. An article is received from a publisher. According to the publisher the article has been peer-reviewed by a plurality of peers. The plurality of peers comprise at least one editor-in-chief, at least one associate editor, and at least one reviewer. A weight factor E is determined for the editor(s)-in-chief. The weight factor E is proportional to an editor-in-chief's relative merit compared to that of other peers in the peer review process. A weight factor F is determined for the associate editor(s). The weight factor F is proportional to an associate editor's relative merit compared to that of other peers in the peer review process. And, a weight factor G is determined for the reviewer(s). The weight factor G is proportional to a reviewer's relative merit compared to that of other peers in the peer review process. The article is scanned for metadata. A number X equal to the total number of editors-in-chief that participated in the peer review process of the article is extracted from the metadata. A number Y equal to the total number of associate editors that participated in the peer review process of the article is extracted from the metadata. A number Z equal to the total number of reviewers that participated in the peer review of the article is extracted from the metadata. And, a number V equal to the total number of revisions of the article during the peer review process. A score S is calculated according to E, F, G, X, Y, Z, and V. The score S is displayed next to a link to the article returned in the search results from the search engine.

### BRIEF DESCRIPTION OF THE DRAWINGS

FIG. 1 shows a system for appraising the extent to which a publication has been reviewed by means of a peer-review process.

FIG. 2 shows a method of appraising the extent to which a publication has been reviewed by means of a peer-review process.

FIG. 3 shows an exemplary web page from a search engine with peer review scores displayed next to a link to an article.

### DETAILED DESCRIPTION

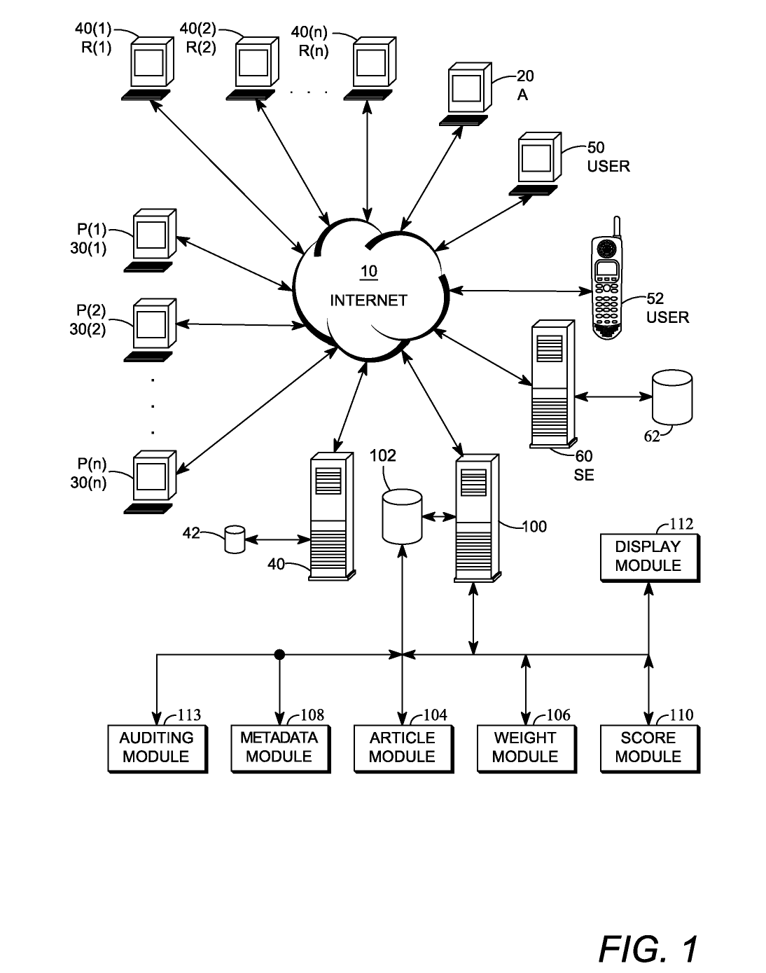

FIG. 1 shows a system for appraising the extent to which a publication has been reviewed by means of a peer-review process such that a user conducting a search with a search engine via an internet connected electronic device can infer the quality of the publication in relation to other publications returned in the search results displayed on the electronic device.

In the peer-review process, an author 20 submits a first revision of an article to a publisher having one or more editors-in-chief and associate editors 30(1..n). The publisher 30 selects one or more reviewers 40(1..n) to review the article, and forwards the article to the reviewers 40(1..n). The reviewers 40 comment on the article and submit the comments to the publisher 30. The publisher 30 forwards the comments, which include comments that the publisher has made, back to the author 20. The author 20 revises the article and sends a second revision to the publisher 30. The second revisions is forwarded and reviewed again, and additional revisions are created as needed until the paper is accepted by the publisher for publication. As part of this process, the publisher may also rate the reviewers 40 on the quality of their review and other factors.

Article revisions, comments, ratings, and the like are stored in database 42 by server 40. The database (40, 42) may store or have access to thousands of articles from thousands of journals. Server 40 is connected to a network 40 such as the internet and therefore can access other databases connected to the internet. The publisher 30, reviewers 40, and author 20 are also in communication with the network 10. The network may comprise any number and types of networks, such as the internet, a local area network (LAN), a wide area network (WAN), a virtual private network (VPN), wired networks, and wireless networks.

The database (40, 42) can be searched by a user with an internet connected electronic device such as a computer 50 or mobile device 52. The mobile device is, for example, a smartphone, laptop computer, iPhone, iPad, and the like.

The database can also be searched by a search engine (60, 62). In one example, a user 50 accesses search engine 60 with a web browser, enters search terms, and the search request is transmitted to server 60. Server 60 executes a search on database 62 and on other internet connected databases 42 and serves the results to user computer 50. The results are displayed in the web browser of user computer 50. The results are ranked according to the algorithm of the search engine 60 and include, at least, a link to an article or web page. The user can select the article or web page by clicking on the link.

One example of a search engine is Google Scholar (http://scholar.google.com/). Other examples, including examples of peer-review systems and methods are described in the following U.S. Patents and Patent Applications, which are hereby incorporated by reference: U.S. Pat. No. 7,007,232, U.S. Pat. No. 7,263,655, U.S. Pat. No. 7,539,938, US2006/0123348, US2008/0147661, US2008/0288324, and US2009/0204469.

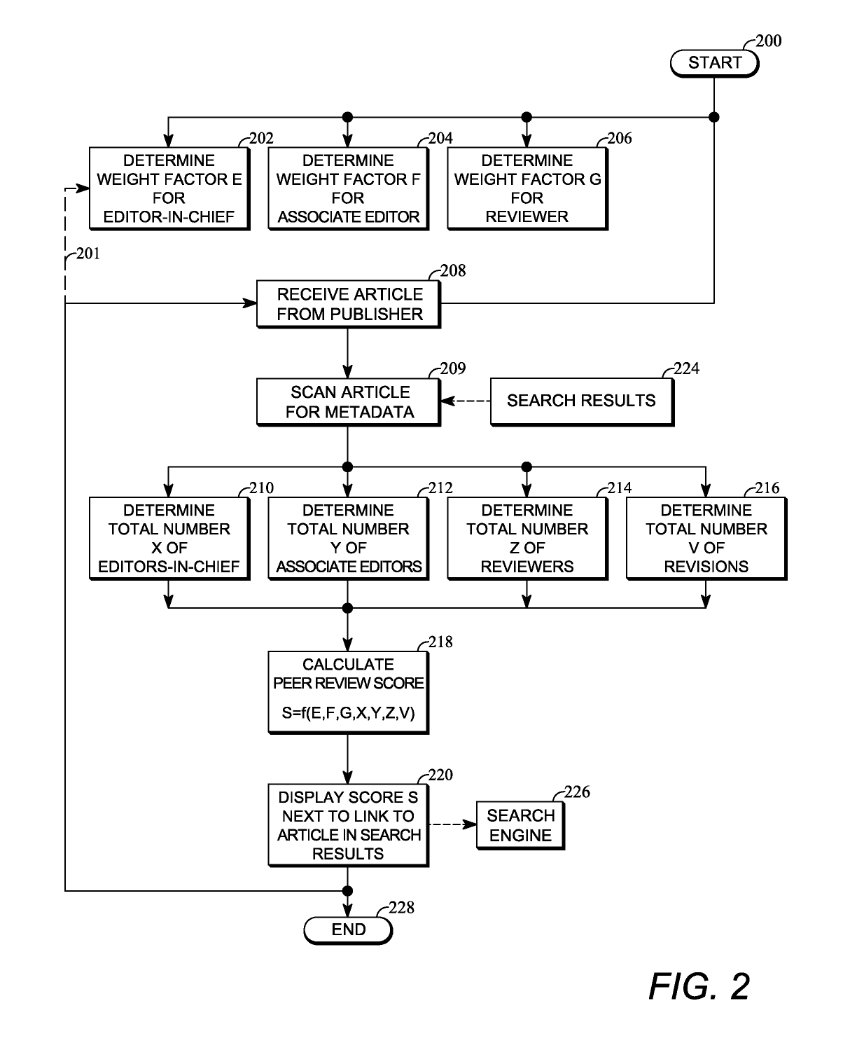

Peer Review Score (PRS) server 100 is also in communication with network 10. Server 100 is a computer having well known components such as a microprocessor, memory, network interface, and a storage device such as a disk drive. The storage device stores computer executable code which when executed by the processor of server 100 causes the computer to carry out the methods described herein and illustrated in FIG. 2.

The server 100 includes a database 102 for storing data such as articles and scores, an article module 104 for receiving an article from a publisher, a weight module 106 for determining weight factors of peers 30 and 40, a metadata module for scanning the article for metadata and determining how many and what types of peers 30 and 40 reviewed the article from author 20, a score module 110 for calculating a peer review score for the article, a display module for displaying the peer review score next to each link to each article returned in the search results from the search engine 60, and an audit module 113 for auditing a score from the score module 110. The details of the modules 102-113 are disclosed below.

FIG. 2 shows a method carried out by the server 100 for appraising the extent to which a publication has been reviewed by means of a peer-review process such that a user conducting a search with a search engine via an internet connected electronic device can infer the quality of the publication in relation to other publications returned in the search results displayed on the electronic device.

An article is received 208 from a publisher. According to the publisher, the article has been peer-reviewed by a plurality of peers. The plurality of peers comprise at least one editor-in-chief (EIC), at least one associate editor (AE), and at least one reviewer (R). The article may be received in response to search results 224 from a search, or the article may be received as part of a process that monitors a publisher's database for new articles, or the article may be received because a publisher transmitted the article to the system.

The terms “transmitting” and “received” are understood herein to include the electronic transfer of a file or a link to a file over a network. If the article is not received in paper form then the article is scanned to convert it into an electronic form. If the electronic form is in an incompatible format, such as a TIFF file, then the form is converted from the incompatible format to a compatible format such a portable document format (pdf). Formats such as TIFF and pdf are merely exemplary and other file formats may be used.

In one example, the article is in a portable document format (pdf) and includes metadata. Metadata may include the total number of peers, the total number of editors-in-chief that participated in the peer review, the total number of associate editors that participated in the peer review, the total number of reviewers that participated in the peer review, and the total number of revisions of the article. One example of a pdf format is defined International Standard ISO 19005-1:2005. Another example is ISO 32000-1. In another example, an XML file is received comprising the metadata which includes information about the peer-review process associated with the article (e.g. X, Y, Z, and V disclosed below) and bibliographic information about the article. It is appreciated that, as used herein, any reference to receiving an article equivalently includes receiving a pdf, or an XML file, or any equivalent combination or motification thereof.

A weight factor E is determined 202 for the editor(s)-in-chief. The weight factor E is proportional to an editor-in-chief's relative merit compared to that of other peers (for example AE and R) in the peer review process.

Similarly, a weight factor F is determined 204 for the associate editor(s). The weight factor F is proportional to an associate editor's relative merit compared to that of other peers (for example EIC and R) in the peer review process.

And, a weight factor G is determined 206 for the reviewer(s). The weight factor G is proportional to a reviewer's relative merit compared to that of other peers (for example EIC and AE) in the peer review process.

In one example, E, F, and G are determined according to the responsibility and accountability level of the peer. For example, E>F>G because an editor-in-chief has the most control over whether an article is published, an associate editor has lesser control, and a reviewer has the least control. In another example, E, F, and G are determined according to the reputations of the peer. In another example, more than one publisher participates in an online marketplace or auction to set values for E, F, and G.

In yet another example, already published articles and their peer-review histories are reviewed manually by a plurality of experts (such as EICs and AEs), scores (which will be disclosed below) are manually assigned to each article based on the review, and values of E, F, and G are determined from the dataset of articles and scores. In this example, values for E, F, and G could be determined by solving sets of linear equations for the score equation below.

In still another example, E, F, and G are constant. In a different example (e.g. branch 201 in FIG. 2), E, F, and G are variable and are recalculated on a periodic basis, according to the journal, according to subject or industry of the article, and the like. It is appreciated that other ways of determining E, F, and G are possible.

After the article is received 208, the article is scanned 209 for metadata. Scanning a pdf file, an XML file, or any other equivalent file format is well understood by those skilled in the art. The metadata is scanned 208 in order to determine how many of each type of peer participated (210-214) in the peer review and how many revisions the article underwent (216).

If the metadata is incomplete or missing, a request is transmitted to the publisher to supply the metadata. The publisher replies and the metadata is received. Then, the metadata is stored with the article (for example in database 102 of FIG. 1)

At step 210 a number X equal to the total number of editors-in-chief that participated in the peer review process of the article is extracted from the metadata. At step 212 a number Y equal to the total number of associate editors that participated in the peer review process of the article is extracted from the metadata. At step 214 a number Z equal to the total number of reviewers that participated in the peer review of the article is extracted from the metadata. And, at step 216 a number V equal to the total number of revisions of the article during the peer review process.

Next, a peer review score S is calculated 218. S is a function of E, F, G, X, Y, Z, and V. In one example, S is not a function of a number of times the article was cited in other publications or a number of links to the article from documents or web pages accessible via the internet. For example, the score S is calculated according to the equation:

S=(E×X+F×Y+G×Z)×V.

As mentioned above, reviewer ratings may also be received for each of the reviewers. The ratings may be obtained by scanning 209 the article for metadata. Alternatively, the reviewer ratings may be obtained by accessing a database (such as database 92 of FIG. 1). Next, an aggregate reviewer rating R is computed from all of the reviewer ratings received. In one example, R equals the mean of all of the reviewer ratings. Then the score S is computed where S is a function of E, F, G, X, Y, Z, V, and R. For example, the score S is calculated according to the following equation:

S=(E×X+F×Y+R×G×Z)×V.

At step 220, the score S is displayed next to a link to the article in the search results. In displaying the score S, the display module (112 of FIG. 1) transmits computer executable code which when executed in the web browser of a computer (such as user computer 50 or 52) causes the web browser to display the score S next to the link retrieved from the search engine. The computer executable code may be transmitted 226 to the search engine, and the search engine may generate additional computer executable code for rendering a webpage of search results with the scores S.

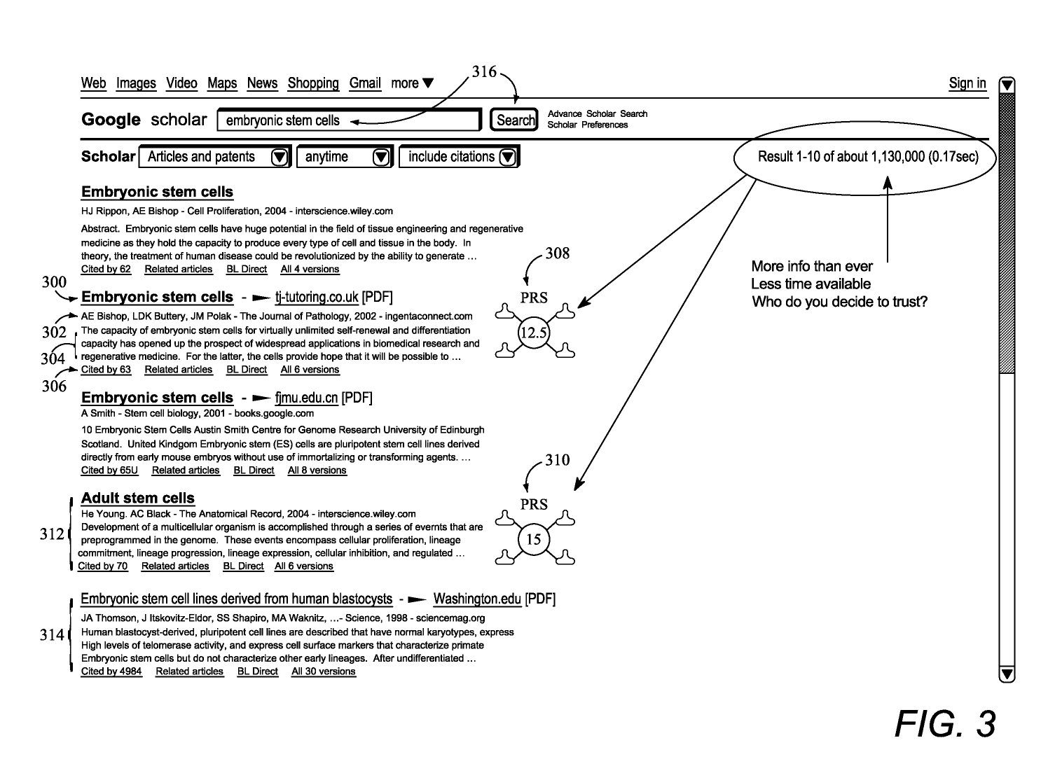

FIG. 3 shows an exemplary web page from a search engine with scores displayed next to a link to an article. A search engine, Google Scholar, was searched for articles about “embryonic stem cells” 316. The results include articles for which a peer review score could not be computed 314, and results (300-308, and 310-312) including a score 308 and 310. The results include a link 300 to the article and a score 308 displayed next to the link 300. For the article 300 the score 308, or peer review score (PRS), equals 12.5. The result returned in 312 has a PRS=15 (310).

The results include additional information such as bibliographic information 301 which, a portion of an abstract 304, and additional information and links 306 such as the number of citation, links to related articles, and the like.

Finally, turning back to FIG. 1, the auditing module 113 audits the score S from the score module 110. In auditing the score, the article is transmitted to an auditor. The auditor may be, for example an independent reviewer or enforcement agency. The auditor computes a score and the auditor's score is compared with the score from the score module 110. Then, for any discrepancy, S is recomputed to have the corrected value received from the auditor. In one example, the auditor returns corrected values for at least one of E, F, G, X, Y, Z, and V and the score module 110 recomputes the score S.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

What is claimed is:

1. A method of appraising the extent to which a publication has been reviewed by means of a peer-review process such that a user conducting a search with a search engine via an internet connected electronic device can infer the quality of the publication in relation to other publications returned in the search results displayed on the electronic device, the method comprising:
(a) receiving an article from a publisher wherein, according to the publisher, the article has been peer-reviewed by a plurality of peers which comprise at least one editor-in-chief (EIC), at least one associate editor (AE), and at least one reviewer (R);
(b) determining a weight factor E that is proportional to an editor-in-chief's relative merit compared to that of other peers in a peer-review process;
(c) determining a weight factor F that is proportional to an associate editor's relative merit compared to that of other peers in a peer-review process;
(d) determining a weight factor G that is proportional to a reviewer's relative merit compared to that of other peers in a peer-review process;
(e) scanning the article for metadata;
(f) determining from the metadata a number X equal to a total number of editors-in-chief that participated in the peer review of the article;
(g) determining from the metadata a number Y equal to a total number of associate editors that participated in the peer review of the article;
(h) determining from the metadata a number Z equal to a total number of reviewers that participated in the peer review of the article;
(i) determining from the metadata a number V equal to a total number of revisions of the article;
(j) calculating a score S according to E, F, G, X, Y, Z, and V; and
(k) displaying the score S next to a link to the article returned in the search results from the search engine.

2. The method of claim 1 wherein the score S is not calculated according to a number of times the article was cited in other publications, and a number of links to the article from documents or web pages accessible via the internet.

3. The method of claim 1 wherein the score S is calculated according to the following equation: S=(E×X+F×Y+G×Z)×V; and

[symbol]

4. The method of claim 1 further comprising:
(l) receiving a reviewer rating for each of the at least one reviewers;
(m) computing an aggregate reviewer rating R from all of the reviewer ratings from the step of (l); and
(n) computing the score S according to the following equation:
S=(E×X+F×Y+R×G×Z)×V.

5. The method of claim 1 further comprising auditing the score S.

6. The method of claim 5 wherein the step of auditing comprises:
(o) transmitting the article to an auditor; and
(p) recomputing S with a corrected value received from the auditor of at least one E, F, G, X, Y, Z, and V.

7. The method of claim 1 wherein the step of receiving in (a) comprises, if the article is not in electronic form, scanning the article to convert it into electronic form.

8. The method of claim 1 wherein the step of scanning in (e) comprises:
(q) if the metadata is incomplete or missing, transmitting a request to the publisher to supply the metadata;
(r) receiving the metadata; and
(s) storing the metadata with the article.

9. A system for appraising the extent to which a publication has been reviewed by means of a peer-review process such that a user conducting a search with a search engine via an internet connected electronic device can infer the quality of the publication in relation to other publications returned in the search results displayed on the electronic device, the system comprising:
means for receiving an article from a publisher wherein, according to the publisher, the article has been peer-reviewed by a plurality of peers which comprise at least one editor-in-chief (EIC), at least one associate editor (AE), and at least one reviewer (R);
means for determining a weight factor E that is proportional to an editor-in-chief's relative merit compared to that of other peers in a peer-review process;
means for determining a weight factor F that is proportional to an associate editor's relative merit compared to that of other peers in a peer-review process;
means for determining a weight factor G that is proportional to a reviewer's relative merit compared to that of other peers in a peer-review process;
means for scanning the article for metadata;
means for determining from the metadata a number X equal to a total number of editors-in-chief that participated in the peer review of the article;
means for determining from the metadata a number Y equal to a total number of associate editors that participated in the peer review of the article;
means for determining from the metadata a number Z equal to a total number of reviewers that participated in the peer review of the article;
means for determining from the metadata a number V equal to a total number of revisions of the article;
means for calculating a score S according to E, F, G, X, Y, Z, and V; and
means for displaying the score S next to a link to the article returned in the search results from the search engine.

10. The system of claim 1 further comprising means for auditing the score S by sending the article to an auditor, receiving corrections, and recomputing the score S if any one of E, F, G, X, Y, Z, and V are corrected.

11. A computer in communication with a communication network for appraising the extent to which a publication has been reviewed by means of a peer-review process such that a user conducting a search with a search engine via an electronic device connected to the communication network can infer the quality of the publication in relation to other publications returned in the search results displayed on the electronic device, the computer comprising a storage device and a microprocessor, the storage device comprising computer executable code which when executed by the microprocessor causes the computer to:
(a) receive an article from a publisher wherein, according to the publisher, the article has been peer-reviewed by a plurality of peers which comprise at least one editor-in-chief (EIC), at least one associate editor (AE), and at least one reviewer (R);
(b) determine a weight factor E that is proportional to an editor-in-chief's relative merit compared to that of other peers in a peer-review process;
(c) determine a weight factor F that is proportional to an associate editor's relative merit compared to that of other peers in a peer-review process;
(d) determine a weight factor G that is proportional to a reviewer's relative merit compared to that of other peers in a peer-review process;
(e) scan the article for metadata;
(f) determine from the metadata a number X equal to a total number of editors-in-chief that participated in the peer review of the article;
(g) determine from the metadata a number Y equal to a total number of associate editors that participated in the peer review of the article;
(h) determine from the metadata a number Z equal to a total number of reviewers that participated in the peer review of the article;
(i) determine from the metadata a number V equal to a total number of revisions of the article;
(j) calculate a score S according to E, F, G, X, Y, Z, and V; and
(k) display the score S next to a link to the article returned in the search results from the search engine.

12. The computer of claim 11 further comprising wherein the computer executable code when executed by the microprocessor cause the computer to audit the score S.
